(19) United States
(12) Patent Application Publication
(10) Pub. No.: US 2021/0142372 A1
(43) Pub. Date: May 13, 2021

(54) AUTOMATIC PRICE AND/OR REWARD ADJUSTMENT BY A BRANDED CARD PROVIDER

(71) Applicant: Comenity LLC, Columbus, OH (US)

(72) Inventors: Bipin SADHWANI, Lewis Center, OH (US); Vinayak SWAMINATHAN, Dublin, OH (US); Sarvesh KOTRA, Lewis Center, OH (US); Suman Rao JANGAMA, Delaware, OH (US); Kshirod PALEI, Columbus, OH (US); Kanthilatha VADREVU, New Albany, OH (US)

(73) Assignee: Comenity LLC, Columbus, OH (US)

(21) Appl. No.: 16/800,632

(22) Filed: Feb. 25, 2020

Related U.S. Application Data
(60) Provisional application No. 62/934,806, filed on Nov. 13, 2019.

(51) Int. Cl. G06Q 30/02

(52) U.S. Cl. CPC G06Q 30/0283; G06Q 30/0235; G06Q 30/0238; G06Q 30/0215

(57) ABSTRACT

Systems and methods for automatic price and/or reward adjustment by a branded card provider is disclosed. One method obtains purchase information for an item purchased by a cardholder. The purchase information for the item is monitored. When it is determined that a change in the purchase information for the item has occurred, a value of the change is determined. The value of the change is automatically credited to an account of the cardholder.

### CROSS-REFERENCE TO RELATED APPLICATIONS (PROVISIONAL)

This application claims priority to and benefit of co-pending U.S. Provisional Patent Application No. 62/934,806 filed on Nov. 13, 2019, entitled “AUTOMATIC PRICE AND/OR REWARD ADJUSTMENT BY A BRANDED CARD PROVIDER” by Bipin Sadhwani et al., and assigned to the assignee of the present application, the disclosure of which is hereby incorporated by reference in its entirety.

### BACKGROUND

Often, a cardholder will purchase an item only to find out later that its price has been reduced, or that a better deal was available. For example, the cardholder could buy a pair of jeans only to find out later that jeans is on sale a day or week later. In another example, the cardholder missed the better offer because they did not see or check a particular communication channel. As such, instead of the cardholder feeling the joy at making the purchase, the cardholder may feel that they were cheated, betrayed, or that their purchase is somehow tainted. This feeling of hostility could result in detriment toward the seller, a bad review, return of the purchased merchandise, and the like. In contrast, the card holder may intentionally hold off on buying the jeans until they are on sale, only to forget about the jeans, buys them somewhere else, or else find out the jeans are sold out by the time the cardholder returns to make the purchase. This is a missed sales opportunity for the merchant that could be addressed if the buyer were made confident that he/she would be credited in some shape or form if the price were to drop within a definite time.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description should not be understood as being drawn to scale unless specifically noted.

FIG. 1A is an exemplary table of purchase information for a single product price change over a certain time period, in accordance with an embodiment.

FIG. 1B is an exemplary table of purchase information for a single product price change using different consumer's purchase information over a certain time period, in accordance with an embodiment.

FIG. 2A is an exemplary table of the branded card provider tracking the reward points for a single brand, in accordance with an embodiment.

FIG. 2B is an exemplary table of the branded card provider tracking the price for a single brand, in accordance with an embodiment.

FIG. 3 is a block diagram of a branded card provider system for automatic price and/or reward adjustment for a cardholder, in accordance with an embodiment.

FIG. 4 is a flowchart of a method for automatic price and/or reward adjustment by a branded card provider, in accordance with an embodiment.

FIG. 5 is a block diagram of an example computer system with which or upon which various embodiments of the present invention may be implemented.

### DESCRIPTION OF EMBODIMENTS

Reference will now be made in detail to embodiments of the subject matter, examples of which are illustrated in the accompanying drawings. While the subject matter discussed herein will be described in conjunction with various embodiments, it will be understood that they are not intended to limit the subject matter to these embodiments. On the contrary, the presented embodiments are intended to cover alternatives, modifications and equivalents, which may be included within the spirit and scope of the various embodiments as defined by the appended claims. Furthermore, in the Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Notation and Nomenclature

Unless specifically stated otherwise as apparent from the following discussions, it is appreciated that throughout the present Description of Embodiments, discussions utilizing terms such as “selecting”, “outputting”, “inputting”, “providing”, “receiving”, “utilizing”, “obtaining”, “updating”, “accessing”, “changing”, “correlating”, “prescreening”, “developing”, “presenting”, “deploying” or the like, often refer to the actions and processes of an electronic computing device/system, such as a desktop computer, notebook computer, tablet, mobile phone, and electronic personal display, among others. The electronic computing device/system manipulates and transforms data represented as physical (electronic) quantities within the circuits, electronic registers, memories, logic, and/or components and the like of the electronic computing device/system into other data similarly represented as physical quantities within the electronic computing device/system or other electronic computing devices/systems.

In the following discussion, the term “retailer” is used to define a company or conglomeration that includes one or more brands. The term “brand” refers to a specific section of the retailer that includes a number of stores. The term “store” refers to a single sales location, a store could be a physical store (e.g., brick and mortar) or it could be a virtual store (e.g., a location that is accessed via the web).

It should also be appreciated that the obtaining or accessing of the cardholder's information conform to applicable privacy laws (e.g., federal privacy laws, state privacy laws, etc.). In one embodiment, prior to accessing any cardholder information, the cardholder affirmatively “opts-in” to the services described herein. As a result, any information is obtained with the cardholder's prior permission. Moreover, depending on present or future requirements, rules and regulations, aspects described herein may be more or less formal.

### Operation

Embodiments described herein provide a branded card provider with the ability to leverage application programming interface (API's) and item identification level data (e.g., SKU, UPC, etc.) from brands during settlement to ensure that the branded cardholder has not overpaid (or been under rewarded) and will not need to return an original item only to rebuy it at a new lower price. For example, in one embodiment, a cardholder purchases a $400 pair of work boots at Johnny's Overalls. Soon after (e.g., within a week), the price of the work boots drops to $350.

Prior to the invention, the cardholder would make the boot purchase (with a price guarantee, a return window-such as 10 days, or the like) the cardholder would then notice the price change, return the work boots for a $400 refund, and then purchase another pair of the same work boots at the new lower price of $350. In a similar example, the cardholder goes to the store to get price adjusted (within return window). In this case, she doesn't get a new pair of boots but just gets the price adjusted. Here, she still has to stand in line and ends up wasting her time, the store associates time, and the like. In another example, the cardholder sees a lower price and buys the same item again online because he doesn't have time to go to the store, then two days later (within the return window), he goes to the store and returns the original purchased item for a full refund. Here the returned boots need to be evaluated by a customer rep and all the extra overhead that such a return entails.

While this is a difficult and time consuming process for the cardholder, it is even more time consuming and cost prohibitive for the retailer. Because the retailer will have to have employee's available to process the return and ring up the new sale. Similarly, the returned work boots would have to be evaluated for wear, tags missing, etc. In many cases, the returned work boots would be sent to an outlet and priced at a price point that is even lower than the sale price. For example, the outlet might price the returned work boots at 20%-50% off the original $400 price (e.g., $200-$320).

While the above buy/return/re-buy scenario seems redundant and archaic, it is the present state of the art due to the use of computer systems at the point of sale (POS) that are used to perform credit account sales that require third party systems to authorize payments and credits, inventory tracking, fraud mitigation, stolen item returns, and the like. As such, instead of simply providing a portion of the money to the cardholder, the store POS will need to use a receipt (or credit account, ID, etc.) to scan into the retailer's system to determine that the purchase was actually made, that it was made within the return window, determine the actual amount paid at the time of purchase, and then provide an authorization for the refund (of the actual amount paid) from the store to the cardholder's credit account provider.

After the return is processed, the cardholder will then need to bring the new discounted item to the POS where the store will need to obtain authorization from the card provider for a new charge to the card to cover the amount of the new purchase.

To overcome the shortcomings of the netcentric computer-based retail environment, in one embodiment, the branded card provider will keep track of a cardholder's purchase and any return/price drop guarantee window (or time frame) associated with the cardholder's purchase. For example, the branded card provider could monitor for purchase price changes using their own (or third party) API's to do web crawling for price drops, to call brand partner provided API's for price checks, use machine learning (ML) and/or artificial intelligence (AI) to predict price drops (such as seasonal price drops, weather related price drops, brand specific special anniversary (or other known dates) sales, monitor their own transaction database to see if a different cardholder has bought the same item at a lesser price, for a better rewards offer, and the like.

For example, during a purchase authorization, the brand will provide the branded card provider with a various level of item identification information usually divided into three levels. Each level is defined by the amount of information that is required or passed to complete a payment with Level 1 having the lowest amount of information requirements and Level III having the highest amount of information requirements. In one embodiment, branded card providers (specially PLCC) are able to get this information from brand partner and then use this information to provide the service disclosed herein. However, all other third party providers that offer this service don't have direct access to level 2 and 3 data. Hence, they require access to your personal email to look for receipts to get item info, etc. Our solution avoids all that headache and need to invade customer's personal email

Level I data is typically associated with consumer transactions and limited purchase data returned to the cardholder. Level I purchasing card data includes information such as: total purchase amount, date, merchant category code, supplier/retailer name, etc.

Level II data includes the same information captured at Level I, plus some or all of the following: sales tax amount, cardholder's accounting code, merchant's tax ID number, applicable minority—and women-owned business status, sales outlet ZIP code, purchase order number, destination zip, tax indicator, requestor name, destination address, destination city, destination state, etc.

Level III data includes the same information captured at Levels I and II, plus some or all of the following: quantities, item ID, item description, commodity code, unit price, extended price, ship to ZIP, freight amount, duty amount, order/ticket number, unit of measure, extended item amount, discount indicator, discount amount, net/gross indicator, tax rate applied, tax type applied, debit or credit indicator and alternate tax identifier, etc.

In one embodiment, by tracking information such as, but not limited to, the item ID, the date of sale, the unit price of the item, a cardholder ID, and the like, the branded card provider can keep track of the price of a specific item. In one embodiment, the branded card provider will also keep track of a cardholder's purchase and any return/price drop guarantee window (or time frame) associated with the cardholder's purchase, to ensure the cardholder receives the best purchase price available during the return/price drop guarantee window.

In one embodiment, the branded card provider could track the price of the specific item sold by a single brand. In another embodiment, the branded card provider could track the price of the specific item sold by a number of brands. An example of the branded card provider tracking the price for a single brand is shown in Table 10 of FIG. 1A. In one embodiment, table 10 includes a seller 1 column, an item identifier 2 column, a date of sale 3 column, a unit price 4 column, a price match time period 5 column, and a cardholder 6 column. Although a number of columns are shown, it should be appreciated that in a different embodiment, there could be more, fewer, or different columns. The use of the number of columns in the table is provided as one embodiment.

In one embodiment, according to Table 10, cardholder 215 would not receive the discounted price from branded card provider as the price drop by Johnny's Overalls occurred more than two weeks after the original purchase and is therefore outside of the price match window. In contrast, cardholder 007 would receive the discounted price from branded card provider as the price drop by Johnny's Overalls occurred less than two weeks after the original purchase and is therefore inside of the price match window. In one embodiment, the price match window could be longer or shorter than the two weeks. Further, in one embodiment, the price match window could be prorated or decrease by percentages based on the time frame. For example, within the first two weeks after the purchase, the cardholder would receive the full discount. After the first two weeks but before four weeks, the cardholder would receive 80% of the discount. After the first four weeks but before six weeks, the cardholder would receive 40% of the discount. After six weeks, the cardholder would no longer receive any discount. Although an example of prorating is discussed herein, it should be appreciated that in another embodiment, the values and/or time windows for the prorating could be different. The differences could be based on the brand, on the branded card provider storage and/or computer processing requirements and costs, etc.

An example of the branded card provider tracking the price for a number of brands is shown in Table 15 of FIG. 1B. In one embodiment, table 15 includes a seller 1 column, an item identifier 2 column, a date of sale 3 column, a unit price 4 column, a price match time period 5 column, and a cardholder 6 column. Although a number of columns are shown, it should be appreciated that in a different embodiment, there could be more, fewer, or different columns. The use of the number of columns in the table is provided as one embodiment.

As evident from Table 15, even when a number of different brands are tracked, cardholder 215 would not receive the discounted price from the branded card provider as the lower price found at Billy's Boots occurred more than two weeks after the original purchase and is therefore outside of the price match window. In contrast, cardholder 007 would receive the discounted price from branded card provider as the lower price at Billy's Boots was found less than two weeks after the original purchase and is therefore inside of the price match window.

In one embodiment, the price match window could be longer or shorter than the two weeks. Further, in one embodiment, the price match window could be prorated or decrease by percentages based on the time frame. For example, within the first two weeks after the purchase, the cardholder would receive the full discount. After the first two weeks but before four weeks, the cardholder would receive 50% of the discount. After the first four weeks but before six weeks, the cardholder would receive 25% of the discount. After six weeks, the cardholder would no longer receive any discount. Although an example of prorating is discussed herein, it should be appreciated that in another embodiment, the values and/or time windows for the prorating could be different. The differences could be based on the brand, on the branded card provider storage and/or computer processing requirements and costs, etc.

In one embodiment, the branded card provider will keep track of a cardholder's purchase and any return/price drop guarantee window (or time frame) associated with the cardholder's purchase. If there is any price drop found during the return/price drop guarantee window, the branded card provider will automatically make a price adjustment with the brand partner (e.g., Johnny's Overalls will see a payment reduction of $50 along with a description of the reason for the payment reduction). In addition, the branded card provider will pass the $50 dollar savings back to the cardholder in the form of a statement credit or a reward.

In one embodiment, the branded card provider will include information regarding the circumstances for the statement credit/reward. For example, the statement would inform the cardholder that the $400 pair of work boots purchased at Johnny's Overalls have had a price drop (within the return/price drop guarantee window) to $350, and the statement credit/reward is provided for that reason.

In one embodiment, the option of whether the cardholder receives a statement credit, or a reward could be based on a cardholder preference. For example, the branded card provider could offer the cardholder with a choice of receiving the monetary (e.g., $50) statement credit or receiving a number of reward points (e.g., 20 reward points for every dollar) instead of the monetary statement credit. In one embodiment, the offered number of reward points is equivalent to the monetary statement credit value. In another embodiment, the offered number of reward points could be greater than the monetary statement credit value.

In one embodiment, the branded card provider will keep track of a cardholder's purchase, any rewards received, and the like over the return/price drop guarantee window (or time frame) associated with the cardholder's purchase. In one embodiment, the branded card provider monitors the data from brands during settlement (and/or from the API's, and the like) to ensure that the branded cardholder has not received a lesser reward during the price match window. For example, in one embodiment, a cardholder purchases a $400 pair of work boots at Johnny's Overalls and receives 400 reward points. Soon after (e.g., within a week), the price of the work boots is still $400 dollars, but the reward points have been raised to 600.

In one embodiment, by tracking information such as, but not limited to, the item ID, the date of sale, the unit price of the item, a cardholder ID/reward tier, a reward amount, and the like, the branded card provider can keep track of the price and the rewards of a specific item.

In one embodiment, the branded card provider could track the reward points for the purchase of the specific item sold by a single brand. In another embodiment, the branded card provider could track the reward points of the specific item sold by a number of brands. An example of the branded card provider tracking the reward points for a single brand is shown in Table 20 of FIG. 2A. In one embodiment, table 20 includes a seller 1 column, an item identifier 2 column, a date of sale 3 column, a unit price 4 column, a price match time period 5 column, a points 21 column, and a cardholder 6 column. Although a number of columns are shown, it should be appreciated that in a different embodiment, there could be more, fewer, or different columns. The use of the number of columns in the table is provided as one embodiment.

As evident from Table 20, (and assuming that all three cardholders are at the same rewards tier and would therefore each be offered the same reward point amount) cardholder 215 would receive the additional 200 reward points from branded card provider as the reward point increase by Johnny's Overalls occurred less than two weeks after the original purchase. Similarly, cardholder 007 would keep the 600 reward points since they are not taken away if the rewards points are lowered after the purchase date. However, cardholder 3156 would only receive the 400 reward points since there is presently no points change after the purchase made by cardholder 3156. In one embodiment, the price match (or points match) window could be longer or shorter than the two weeks.

In one embodiment, the points match could be retroactive for the given price match window. For example, cardholder 316 would receive the additional 200 reward points from branded card provider as the reward points decrease by Johnny's Overalls occurred less than two weeks prior to the original purchase.

In one embodiment, if there is a reward point change found during the return/price drop guarantee window, the branded card provider will automatically make a reward point adjustment with the brand partner and pass the extra reward points back to the cardholder.

In one embodiment, the branded card provider will include information regarding the circumstances for the extra rewards points. For example, the statement would inform the cardholder that the $400 pair of work boots purchased at Johnny's Overalls have had a rewards increase (within the return/price drop guarantee window) from 400 to 600 rewards points, and the 200 reward points increase has been provided for that reason.

In one embodiment, the branded card provider will also keep track of a cardholder's purchase and any return/price drop guarantee window (or time frame) associated with the cardholder's purchase, to ensure the cardholder receives the best purchase price available during the return/price drop guarantee window and also to ensure that the branded cardholder has not received a lesser reward during the price match window.

In one embodiment, the branded card provider leverage API's and item identification data from brands during settlement (and/or from the API's, and the like) to monitor the item price, associated rewards, and the like. For example, in one embodiment, a cardholder purchases a $400 pair of work boots at Johnny's Overalls and receives 400 reward points. Soon after (e.g., within a week), the price of the work boots is still $400 dollars, but the reward points have been raised to 600. Then, within four days, the price of the work boots drops to $350 while the rewards points drop to 500.

In one embodiment, by tracking information such as, but not limited to, the item ID, the date of sale, the unit price of the item, a cardholder ID/reward tier, a reward, and the like, the branded card provider can keep track of the price and the rewards of a specific item.

In one embodiment, the branded card provider could track the price of the specific item sold by a single brand. In another embodiment, the branded card provider could track the price of the specific item sold by a number of brands. An example of the branded card provider tracking the price for a single brand is shown in Table 25 of FIG. 2B. In one embodiment, table 25 includes a seller 1 column, an item identifier 2 column, a date of sale 3 column, a unit price 4 column, a price match time period 5 column, a points 21 column, and a cardholder 6 column. Although a number of columns are shown, it should be appreciated that in a different embodiment, there could be more, fewer, or different columns. The use of the number of columns in the table is provided as one embodiment.

As evident from Table 25 of FIG. 2B, cardholder 215 would not receive the discounted price from branded card provider as the price drop by Johnny's Overalls occurred more than two weeks after the original purchase and is therefore outside of the price match window. However, cardholder 215 would receive the additional 200 reward points from branded card provider as the reward point increase by Johnny's Overalls occurred less than two weeks after the original purchase.

In one embodiment, cardholder 007 would receive the discounted price from branded card provider as the price drop by Johnny's Overalls occurred less than two weeks after the original purchase and is therefore inside of the price match window. Further, in one embodiment, cardholder 007 would keep the 600 reward points since they are not taken away if the rewards points are lowered after the purchase date.

In one embodiment, cardholder 3156 would only remain at the paid price and the 400 reward points since there is presently no price or points change after the purchase was made by cardholder 3156. In one embodiment, the price match (or points match) window could be longer or shorter than the two weeks.

In one embodiment, the points match could be retroactive for the given price match window. For example, if the price window was retroactive, cardholder 316 would receive the additional 200 reward points from branded card provider as the reward points decrease by Johnny's Overalls occurred less than two weeks prior to the original purchase.

In one embodiment, if there is a money and/or reward point change found during the return/price drop guarantee window, the branded card provider will automatically make a monetary and/or reward point adjustment with the brand partner and pass the extra reward points back to the cardholder.

In one embodiment, the branded card provider will include information regarding the circumstances for the extra monetary and/or reward points. For example, the statement would inform cardholder 215 that the $400 pair of work boots purchased at Johnny's Overalls have had a rewards increase (within the return/price drop guarantee window) from 400 to 600 points, and the reward points increase has been provided for that reason. Similarly, in one embodiment, the statement would inform cardholder 007 that the $400 pair of work boots purchased at Johnny's Overalls have had a price reduction (within the return/price drop guarantee window) from $400 to $350, and the statement credit/rewards point increase has been provided for that reason.

In one embodiment, the option of whether the cardholder receives a statement credit, or a reward could be based on a cardholder preference. For example, the branded card provider could offer cardholder 007 with a choice of receiving the monetary (e.g., $50) statement credit or receiving a number of reward points (e.g., 20 reward points for every dollar) instead of the monetary statement credit. In one embodiment, the offered number of reward points is equivalent to the monetary statement credit value. In another embodiment, the offered number of reward points could be greater than the monetary statement credit value.

In one embodiment, the cardholder would have to buy-in to the automatic price adjustment option. For example, the cardholder could be offered an annual fee to join the program. In one embodiment, the program could be for a single brand partner, or for all of the brand partner accounts held by the cardholder. For example, if the cardholder has a Johnny's overalls branded card and a Tractorman branded card from the same branded card provider, the buy-in is for a single card, e.g., the cardholder would have to pay per card for the price tracking service.

In one embodiment, a single price buy-in will cover any/all of the branded cards that the cardholder holds, that are managed by the same branded card provider, (e.g., price drops for purchases made at both Johnny's overalls branded card and the Tractorman branded card would be monitored).

In yet another embodiment, the price of the buy-in for each additional branded card that the cardholder holds, and that are managed by the same branded card provider, will be offered at a reduced rate. For example, the buy-in for the Johnny's overalls branded card would be the standard price, while the buy-in for the Tractorman branded card (and any other cards) would each be reduced (e.g., 50% less than the standard price).

In one embodiment, the price of the buy-in for each additional branded card that the cardholder holds, and that are managed by the same branded card provider, will be offered at a continually reduced rate. For example, the buy-in for the Johnny's overalls branded card would be the standard price, while the buy-in for the Tractorman branded card would be reduced (e.g., 50% less than the standard price), the buy-in for a third branded card would be further reduced (e.g., 75% less than the standard price), etc.

FIG. 3 is a block diagram of a branded card provider system 310 for automatic price and/or reward adjustment shown in accordance with an embodiment. In one embodiment, branded card provider system 310 receives purchase information 305 and provides account credit 350. In one embodiment, branded card provider system 310 is a computing system such as computer system 500 described in detail in the FIG. 5 discussion herein. In one embodiment, branded card provider system 310 includes a cardholder account identifier 325, an item monitor 335, a change in value evaluator 340, and an account creditor 345. In one embodiment, branded card provider system 310 utilizes cloud 326 to interact with one or more of a branded card provider database 327, internet web pages 328, and a brand database 329.

As described in detail herein, cardholder account identifier 325 receives purchase information 305 when a cardholder purchase an item. Although the discussion refers to an item, the technology is well suited for tracking some or all items purchased by the cardholder at any or all times that the cardholder uses the branded card to make a purchase. The use of an item being purchased in the present discussion of provided merely for purposes of brevity and clarity.

In one embodiment, purchase information 305 includes aspects such as, but not limited to, the item ID, the date of sale, the unit price of the item, a cardholder ID/reward tier, a reward, a price/reward matching time period, and the like.

In one embodiment, cardholder account identifier 325 identifies the cardholder and also adds the purchase information 305 to branded card provider database 327 via cloud 326. In one embodiment, cardholder account identifier 325 will pass the item descriptor to item monitor 335 who will monitor the item for any changes in value, rewards, or the like for the price matching time period (if such a time period exists).

Item monitor 335 will use the item ID to search for any changes to the price and/or rewards for the item as compared to the price and/or rewards provided in purchase information 305. In one embodiment, item monitor 335 will interact with one or more of a branded card provider database 327 (or databases), internet web pages 328, one or more brand database 329, and the like to monitor any changes to the price and/or rewards for the item. In one embodiment, Item monitor 335 will access the different search locations using cloud 326. An example of cloud 326 is a network such as the Internet, local area network (LAN), wide area network (WAN), private network, or the like.

In general, one or more of database 327 and/or database 329 may include store specific data, brand specific data, retailer specific data, a shared database, a conglomerate database, a portion of a larger storage database, and the like. Moreover, databases 327-329 could be local databases, virtual databases, cloud databases, a plurality of databases, or a combination thereof.

Change in value evaluator 340, and account creditor 345 are described in further detail in the description of FIG. 4.

With reference now to FIG. 4 in conjunction with FIG. 3, a flowchart 400 of a method for automatic price and/or reward adjustment by a branded card provider is shown in accordance with an embodiment.

With reference now to 410 of FIG. 4 and FIG. 3, one embodiment obtains purchase information 305 for an item purchased by a cardholder. In one embodiment, the purchase information 305 is obtained by cardholder account identifier 325 of branded card provider system 310.

Referring now to 420 of FIG. 4 and FIG. 3, one embodiment monitors the purchase information for the item. In one embodiment, item monitor 335 of branded card provider system 310 continuously monitors the purchase information for the item. In another embodiment, item monitor 335 of branded card provider system 310 continuously monitors the purchase information for the item until the period of time defined by the brand has expired.

In one embodiment, item monitor 335 of branded card provider system 310 monitors the purchase information for the item only from a brand from which the item was purchased. In other words, the price match would be only for the given brand, e.g., if the brand changes the price for the item (e.g., puts the item on sale, takes the item off of sale, offers a coupon for the item, changes a rewards value for the purchase of the item, or the like). The item monitor 335 would not monitor other brands or retailers for purchase information 305 for the item.

In one embodiment, item monitor 335 uses cloud 226 (which could be one or a plurality of different local, secure, open, or other network connections) to gain access to one or more different item monitoring databases. For example, item monitor 335 could monitor one or more Internet web pages 328 of the brand for the purchase information for the item; use a brand level API to monitor a brand's purchase information (e.g., brand database 329) for the item; and/or monitor transaction database of the branded card provider (e.g., brand database 329). In one embodiment, item monitor 335 would monitor brand database 329for purchase information for the item received from any other brand cardholders.

In one embodiment, item monitor 335 of branded card provider system 310 monitors the purchase information for the item from any retailer that is selling the item. In other words, the price match would be for any retailer, any retailer associated with the branded card provider system 310, and the like. Thus, item monitor 335 would monitor other brands and/or retailers for purchase information for the item.

In one embodiment, item monitor 335 uses cloud 226 (which could be one or a plurality of different local, secure, open, or other network connections) to gain access to one or more different item monitoring databases. For example, item monitor 335 could monitor one or more Internet web pages 328 for the purchase information for the item; use an API from the branded card provider to monitor all brands supported by the branded card provider (e.g., brand database 329) for the item; and/or monitor transaction database of the branded card provider (e.g., brand database 329). In one embodiment, item monitor 335 would monitor brand database 329 for purchase information for the item received from any other cardholders of some or all brands supported by the branded card provider.

With reference now to 430 of FIG. 4 and FIG. 3, one embodiment determines that a change in the purchase information for the item has occurred. In one embodiment, item monitor 335 of branded card provider system 310 determines that there has been a change in the purchase information for the item. In general, the change could be a price increase, a price decrease, a new rewards offer added to the item's purchase, a rewards offer increase, a rewards offer decrease, and the like.

In one embodiment, the purchase information 305 will also include a period of time defined by the brand from which the item was purchased. The period of time would be similar to the price matching time described herein. For example, the period of time could be three weeks. As such, if a change in the purchase information for the item occurs within the (three week) period of time, then the change in the purchase information for the item will be evaluated. However, in one embodiment, if the change in the purchase information for the item occurs after the period of time had expired (or run out), then the change in the purchase information for the item will not be evaluated.

Referring now to 440 of FIG. 4 and FIG. 3, one embodiment determines a value of the change. In one embodiment, change in value evaluator 340 of branded card provider system 310 determines the value of the change. For example, if the price has increased or the rewards offer has been reduced, then the value of the change is of no value to the cardholder that made the purchase and no change will be made to the cardholders account.

In contrast, if the price has been reduced or the rewards offer has been increased, then the value of the change is of value to the cardholder that made the purchase and change in value evaluator 340 will develop the value of the change to be provided to the cardholders account.

For example, item monitor 335 determines that the change in the purchase information for the item is a lower price of the item. In one embodiment, change in value evaluator 340 will determine a monetary value for the difference between a purchase price paid by the cardholder and the now lower price of the item (e.g., the cardholder paid $75 and the item is now selling for $50). This determined monetary value change (e.g., $25) will be provided from change in value evaluator 340 to account creditor 345.

In another example, item monitor 335 determines that the change in the purchase information for the item is an increase in a rewards offer for purchasing the item. In one embodiment, change in value evaluator 340 will determine a difference in the rewards value received by the cardholder and the now higher rewards offer for purchasing the item (e.g., the cardholder received 100 points and the rewards offer for purchasing the item is now 200 points). This determined reward value change (e.g., 100 points) will be provided from change in value evaluator 340 to account creditor 345.

In another example, item monitor 335 determines that the change in the purchase information for the item is a lower price of the item. In one embodiment, change in value evaluator 340 will determine a monetary value for the difference between a purchase price paid by the cardholder and the now lower price of the item (e.g., the cardholder paid $75 and the item is now selling for $50), so the determined monetary value change is $25. In one embodiment, change in value evaluator 340 will also determine a rewards offer (e.g., a number of points, coupon, etc.) that is equal to or greater than the determined monetary value change (e.g., $25 dollars is equivalent to 250 points). In one embodiment, if branded card provider system 310 (or the underlying brand) would prefer the customer to receive rewards instead of the monetary value, change in value evaluator 340 could increase the number of offered reward points (e.g., 300 points instead of 250) to give the cardholder a reason to take the rewards offer instead of the monetary statement credit. In one embodiment, change in value evaluator 340 could also provide a combination of a portion of the monetary value and a portion of the rewards offer.

Once the monetary value change (e.g., $25) and the rewards offer (e.g., 300 points—e.g., a 50 point extra value) are determined, the information will be provided from change in value evaluator 340 to account creditor 345. At that time account creditor 345 would contact the cardholder and provide the cardholder with the option to select, the monetary value, the rewards offer, or the combination of the monetary value and the rewards offer.

With reference now to 450 of FIG. 4 and FIG. 3, one embodiment automatically credits the value of the change to an account of the cardholder. That is, account creditor 345 of branded card provider system 310 will provide an account credit 350 to the account of the cardholder. In one embodiment, the account credit 350 is a monetary statement credit. In one embodiment, the account credit 350 is a rewards offer increase. In one embodiment, the account credit 350 is a combination of a monetary statement credit and a rewards offer increase.

With reference now to FIG. 5, portions of the technology for providing a communication composed of computer-readable and computer-executable instructions that reside, for example, in a non-transitory computer-readable medium, a non-transitory computer-readable storage medium, or in non-transitory computer-readable storage media of a computer system. That is, FIG. 5 illustrates one example of a type of computer that can be used to implement embodiments of the present technology. FIG. 5 represents a system or components that may be used in conjunction with aspects of the present technology. In one embodiment, some or all of the components described herein may be combined with some or all of the components of FIG. 5 to practice the present technology.

FIG. 5 illustrates an example computer system 500 used in accordance with embodiments of the present technology. It is appreciated that system 500 of FIG. 5 is an example only and that the present technology can operate on or within a number of different computer systems including general purpose networked computer systems, embedded computer systems, routers, switches, server devices, user devices, various intermediate devices/artifacts, stand-alone computer systems, mobile phones, personal data assistants, televisions and the like. As shown in FIG. 5, computer system 500 of FIG. 5 is well adapted to having peripheral computer readable media 502 such as, for example, a disk, a compact disc, a flash drive, and the like coupled thereto.

Computer system 500 of FIG. 5 includes an address/data/control bus 504 for communicating information, and a processor 506A coupled to bus 504 for processing information and instructions. As depicted in FIG. 5, system 500 is also well suited to a multi-processor environment in which a plurality of processors 506A, 506B, and 506C are present. Conversely, system 500 is also well suited to having a single processor such as, for example, processor 506A. Processors 506A, 506B, and 506C may be any of various types of microprocessors. Computer system 500 also includes data storage features such as a computer usable volatile memory 508, e.g., random access memory (RAM), coupled to bus 504 for storing information and instructions for processors 506A, 506B, and 506C.

System 500 also includes computer usable non-volatile memory 510, e.g., read only memory (ROM), coupled to bus 504 for storing static information and instructions for processors 506A, 506B, and 506C. Also present in system 500 is a data storage unit 512 (e.g., a magnetic disk drive, optical disk drive, solid state drive (SSD), and the like) coupled to bus 504 for storing information and instructions. Computer system 500 also includes an optional alpha-numeric input device 514 including alphanumeric and function keys coupled to bus 504 for communicating information and command selections to processor 506A or processors 506A, 506B, and 506C. Computer system 500 also includes an optional cursor control device 516 coupled to bus 504 for communicating user input information and command selections to processor 506A or processors 506A, 506B, and 506C. Optional cursor control device may be a touch sensor, gesture recognition device, and the like. Computer system 500 of the present embodiment also includes an optional display device 518 coupled to bus 504 for displaying information.

Referring still to FIG. 5, optional display device 518 of FIG. 5 may be a liquid crystal device, cathode ray tube, OLED, plasma display device or other display device suitable for creating graphic images and alpha-numeric characters recognizable to a user. Optional cursor control device 516 allows the computer user to dynamically signal the movement of a visible symbol (cursor) on a display screen of display device 518. Many implementations of cursor control device 516 are known in the art including a trackball, mouse, touch pad, joystick, non-contact input, gesture recognition, voice commands, bio recognition, and the like. In addition, special keys on alpha-numeric input device 514 capable of signaling movement of a given direction or manner of displacement. Alternatively, it will be appreciated that a cursor can be directed and/or activated via input from alpha-numeric input device 514 using special keys and key sequence commands.

System 500 is also well suited to having a cursor directed by other means such as, for example, voice commands. Computer system 500 also includes an I/O device 520 for coupling system 500 with external entities. For example, in one embodiment, I/O device 520 is a modem for enabling wired or wireless communications between system 500 and an external network such as, but not limited to, the Internet or intranet. A more detailed discussion of the present technology is found below.

Referring still to FIG. 5, various other components are depicted for system 500. Specifically, when present, an operating system 522, applications 524, modules 526, and data 528 are shown as typically residing in one or some combination of computer usable volatile memory 508, e.g. random-access memory (RAM), and data storage unit 512. However, it is appreciated that in some embodiments, operating system 522 may be stored in other locations such as on a network or on a flash drive; and that further, operating system 522 may be accessed from a remote location via, for example, a coupling to the internet. In one embodiment, the present technology, for example, is stored as an application 524 or module 526 in memory locations within RAM 508 and memory areas within data storage unit 512. The present technology may be applied to one or more elements of described system 500.

System 500 also includes one or more signal generating and receiving device(s) 530 coupled with bus 504 for enabling system 500 to interface with other electronic devices and computer systems. Signal generating and receiving device(s) 530 of the present embodiment may include wired serial adaptors, modems, and network adaptors, wireless modems, and wireless network adaptors, and other such communication technology. The signal generating and receiving device(s) 530 may work in conjunction with one or more communication interface(s) 532 for coupling information to and/or from system 500. Communication interface 532 may include a serial port, parallel port, Universal Serial Bus (USB), Ethernet port, Bluetooth, thunderbolt, near field communications port, WiFi, Cellular modem, or other input/output interface. Communication interface 532 may physically, electrically, optically, or wirelessly (e.g., via radio frequency) couple computer system 500 with another device, such as a mobile phone, radio, or computer system.

The computing system 500 is only one example of a suitable computing environment and is not intended to suggest any limitation as to the scope of use or functionality of the present technology. Neither should the computing environment be interpreted as having any dependency or requirement relating to any one or combination of components illustrated in the example computing system 500.

The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments may be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What is claimed is:

1. A computer-implemented method comprising:
obtaining, at a computer system of a branded card provider, purchase information for an item purchased by a cardholder;
monitoring, at the computer system, the purchase information for the item;
determining, at the computer system, that a change in the purchase information for the item has occurred;
determining, at the computer system, a value of the change; and
automatically crediting, at the computer system, the value of the change to an account of the cardholder.

2. The computer-implemented method of claim 1, further comprising:
monitoring the purchase information for the item for a period of time, the period of time defined by a brand from which the item was purchased;
determining that the change in the purchase information for the item has occurred within the period of time; and
automatically crediting the account of the cardholder.

3. The computer-implemented method of claim 1, wherein monitoring the purchase information for the item further comprises:
monitoring the purchase information for the item for a period of time, the period of time defined by a brand from which the item was purchased
determining that the change in the purchase information for the item has occurred after the period of time has tolled; and
providing no credit to the account of the cardholder.

4. The computer-implemented method of claim 1, further comprising:
monitoring the purchase information for the item only from a brand from which the item was purchased, the monitoring comprising:
monitoring one or more Internet websites of the brand for the purchase information for the item;
using a brand level API for monitoring a brand's purchase information for the item; and
monitoring a transaction database of the branded card provider for purchase information for the item received from any other cardholders for the brand.

5. The computer-implemented method of claim 1, further comprising:
monitoring the purchase information for the item from any retail provider, the monitoring comprising:
monitoring one or more Internet websites for the purchase information for the item;
using an API from the branded card provider to monitor all brands supported by the branded card provider for purchase information for the item; and
monitoring a transaction database of the branded card provider for purchase information for the item received from any other cardholders of all brands supported by the branded card provider.

6. The computer-implemented method of claim 1, further comprising:
determining that the change in the purchase information for the item is a lower price of the item;
determining a monetary value for a difference between a purchase price paid by the cardholder and the lower price of the item; and
automatically crediting the account of the cardholder with the determined monetary value.

7. The computer-implemented method of claim 1, further comprising:
determining that the change in the purchase information for the item is a lower price of the item;
determining a monetary value for a difference between a purchase price paid by the cardholder and the lower price of the item;
providing the cardholder with an option to select either the monetary value in a statement credit, a rewards offer that is equal to or greater in value than the monetary value, or a combination of a portion of the monetary value and a portion of the rewards offer that is equal to or greater in value that the monetary value; and
automatically crediting the account of the cardholder based on the cardholder's selected option.

8. The computer-implemented method of claim 1, further comprising:
determining that the change in the purchase information for the item is an increase in a rewards offer for purchasing the item; and
automatically crediting the account of the cardholder with the increased rewards offer.

9. A non-transitory computer-readable storage medium having instructions embodied therein that when executed by a computer system, cause one or more processors of the computer system to perform a method comprising:
obtaining purchase information for an item purchased by a cardholder;
monitoring the purchase information for the item;
determining that a change in the purchase information for the item has occurred;
determining a value of the change; and
automatically crediting the value of the change to an account of the cardholder.

10. The non-transitory computer-readable storage medium of claim 9, further comprising:
monitoring the purchase information for the item for a period of time, the period of time defined by a brand from which the item was purchased;
determining that the change in the purchase information for the item has occurred within the period of time; and
automatically crediting the account of the cardholder.

11. The non-transitory computer-readable storage medium of claim 9, further comprising:
monitoring the purchase information for the item for a period of time, the period of time defined by a brand from which the item was purchased;
determining that the change in the purchase information for the item has occurred after the period of time has tolled; and
providing no credit to the account of the cardholder.

12. The non-transitory computer-readable storage medium of claim 9, wherein the monitoring of the purchase information for the item further comprises:
monitoring one or more Internet websites for the purchase information for the item;
using an API from a branded card provider to monitor all brands supported by the branded card provider for purchase information for the item;
using machine learning to predict a price drop, the predicted price drop selected from the group consisting of: a seasonal price drop, a weather related price drop, and a brand specific special sales date; and
monitoring a transaction database of the branded card provider for purchase information for the item received from any other cardholders of the branded card provider.

13. The non-transitory computer-readable storage medium of claim 9, further comprising:
determining that the change in the purchase information for the item is a lower price of the item;
determining a monetary value for a difference between a purchase price paid by the cardholder and the lower price of the item; and
automatically crediting the account of the cardholder with the determined monetary value.

14. The non-transitory computer-readable storage medium of claim 9, further comprising:
determining that the change in the purchase information for the item is a lower price of the item;
determining a monetary value for a difference between a purchase price paid by the cardholder and the lower price of the item;
providing the cardholder with an option to select either the monetary value in a statement credit, a rewards offer that is equal to or greater in value than the monetary value, or a combination of a portion of the monetary value and a portion of the rewards offer that is equal to or greater in value that the monetary value; and
automatically crediting the account of the cardholder with the cardholder's selected option.

15. The non-transitory computer-readable storage medium of claim 9, further comprising:
determining that the change in the purchase information for the item is an increase in a rewards offer for purchasing the item; and
automatically crediting the account of the cardholder with the increased rewards offer.

16. A system comprising:
a display;
a memory storing instructions; and
one or more processors, executing the instructions, the one or more processors to:
obtain a purchase information for an item purchased by a cardholder;
monitor the purchase information for the item;
determine that a change in the purchase information for the item has occurred;
determine a value of the change; and
automatically credit the value of the change to an account of the cardholder.

17. The system of claim 16, wherein the one or more processors are further to:
monitor the purchase information for the item for a period of time, the period of time defined by a brand from which the item was purchased;
determine that the change in the purchase information for the item has occurred within the period of time; and
automatically credit the account of the cardholder.

18. The system of claim 16, wherein the monitor of the purchase information for the item further causes the one or more processors to:
search one or more Internet websites for the purchase information for the item;
utilize an API from a branded card provider to monitor all brands supported by the branded card provider for purchase information for the item;
predict a price drop, the predicted price drop selected from the group consisting of: a seasonal price drop, a weather related price drop, and a brand specific special sales date; and
monitor a transaction database of the branded card provider for purchase information for the item received from any other cardholders of the branded card provider.

19. The system of claim 16, wherein the one or more processors are further to:
determine that the change in the purchase information for the item is a lower price of the item;
determine a monetary value for a difference between a purchase price paid by the cardholder and the lower price of the item;
provide the cardholder with an option to select either the monetary value in a statement credit, or a rewards offer that is equal to or greater in value than the monetary value; and
automatically credit the account of the cardholder with the cardholder's selected option.

20. The system of claim 16, wherein the one or more processors are further to:
determine that the change in the purchase information for the item is an increase in a rewards offer for purchasing the item; and
automatically credit the account of the cardholder with the increased rewards offer.
